(19) United States
(12) Patent Application Publication
(10) Pub. No.: US 2023/0311349 A1
(43) Pub. Date: Oct. 5, 2023

(54) DOUBLE-EDGED ART KNIFE

(71) Applicant: NINGBO XINGWEI CUTTING-TOOLS TECHNOLOGY CO., LTD., Ningbo (CN)

(72) Inventors: Jianfu Du, Ningbo (CN); Mingxiang Pan, Ningbo (CN); Qi Yao, Ningbo (CN)

(21) Appl. No.: 18/330,524

(22) Filed: Jun. 7, 2023

(30) Foreign Application Priority Data
Apr. 10, 2023 (CN) 202320825543.1

(51) Int. Cl. B26B 5/00; B25G 1/08

(52) U.S. Cl. CPC B26B 5/003; B25G 1/08; B26B 9/02

(57) ABSTRACT

The present disclosure discloses a double-edged art knife, including a knife shell and a knife holder; the knife shell is provided with an accommodating cavity and an opening; the opening is formed in a front end of the knife shell; the knife holder is separably mounted in the accommodating cavity of the knife shell; the opening is divided by the knife holder into a first opening and a second opening; the knife holder includes a knife rest and a pair of moving components; the moving components are symmetrically arranged on two sides of the knife rest; the moving components include a first moving component and the second moving component.

### TECHNICAL FIELD

The present disclosure relates to the technical field of art knives, specifically to a double-edged art knife.

### BACKGROUND

Traditional art knives are knives for art and handicrafts, and are mainly used to cut soft materials, such as colored paper. The art knives are mostly composed of a plastic handle and a blade, and are of a pulling type structure. In order to meet application requirements, heavy-duty art knives are gradually becoming common. The heavy-duty art knives can be used for carving, cutting, and the like, and are mainly for cutting hard materials such as an acrylic plate. Art knives are applied to more and more fields, such as paving, packaging, transportation, carpet installation, and other cutting purposes of polyvinyl chloride (PVC) floorings and rubber floorings in buildings. In order to meet different requirements of customers, art knives with different blades and handles are being continuously developed.

In different applications, a user needs to select a suitable art knife for operation. For example, for linear or curved cutting of different materials, art knives with different blades need to be used. Therefore, operators often need to carry multiple art knives. During replacement of an art knife, the operator needs to find out an appropriate art knife from a disordered tool kit, which wastes the work time. Continuously replacing the art knives can affect the operation experience. At the same time, the work efficiency can also be reduced. Moreover, most of the current art knives are designed for right-handers, which conforms to a usage habit of right-handers. An operating part corresponds to a pressing position of the right thumb. When a blade is pushed out by the right thumb, a cutting edge naturally faces downward. If the art knife is operated with the left hand, the cutting edge would face upward. Therefore, left-handers often need a specific left-edged art knife. Since there are a few of left-edged art knives, a left-edged art knife is more expensive than a right-edged art knife, and there are also a fewer of types for selection. If an art knife with an operating portion at an upper end of a handle, although the art knife can be operated with both the left and right hands, due to the complexity of a locking structure of the art knife, the manufacturing cost is much higher than that of a side-press art knife, which cannot be promoted for practical use.

### SUMMARY

One objective of the present disclosure is to provide a double-edged art knife. Two blades are assembled in two groups of symmetric moving components, so that 360° single-hand switching of two kinds of art knives is quickly achieved, and the work efficiency is improved.

Another objective of the present disclosure is to provide a double-edged art knife, which has a compact structure. By using a configuration type assembled structure, it is convenient to change edge directions of blades, which is helpful to achieve a switching operation of the left hand and the right hand, and improves the universality of the art knife.

Another objective of the present disclosure is to provide a double-edged art knife. Two different blades are configured for one art knife, and the corresponding blades are pushed out for use in a lateral operation manner, to ensure the bearing strength of a knife holder, without additionally increasing a thickness of the art knife, so that a complicated locking structure is not required, the operation is simple, and the cost is low.

In order to achieve the above objectives, technical solutions adopted in the present disclosure are as follows: A double-edged art knife includes a knife shell and a knife holder; the knife shell is provided with an accommodating cavity and an opening; the opening is formed in a front end of the knife shell; the knife holder is separably mounted in the accommodating cavity of the knife shell; the opening is divided by the knife holder into a first opening and a second opening; the knife holder includes a knife rest and a pair of moving components; the moving components are symmetrically arranged on two sides of the knife rest; the moving components include a first moving component and the second moving component; the first moving component bears a first blade and can push the first blade along one side of the knife shell to extend out of the first opening or retract back to the accommodating cavity; and the second moving component bears a second blade and pushes the second blade along the other side of the knife shell to extend out of the second opening or retract back to the accommodating cavity.

As a preference, the knife rest is provided with sliding portions, side flange groups, and retaining portions on both a front surface and a back surface; the sliding portions are located on a front side of the knife rest; the side flange groups protrude along two side edges of the sliding portions; the retaining portions are located on a rear side of the knife rest; the moving components respectively face the front surface and the back surface of the knife rest; rear ends of the moving components are elastically connected to the retaining portions; two side edges of the moving components are slidably connected to the side flange groups respectively, so that the moving components slide back and forth along the sliding portions.

As a preference, each moving component includes a main body portion, an extending portion, and an elastic member; the extending portion extends from the main body portion to the elastic member; the elastic member is deformably connected to the extending portion and the corresponding retaining portion of the knife rest; the main body portion includes an operating portion and a positioning portion; the operating portion is located on an outer surface of the main body portion; a knife shell main body is provided with a pair of operating holes; the operating holes are separately formed in two side surfaces of the knife shell main body, so that the various operating portions are located in the operating holes of the knife shell main body; the positioning portion protrudes out of an inner surface of the main body portion; the positioning portion faces the corresponding sliding portion of the knife rest, so that the blade is detachably fixed to the positioning portion; and a protrusion height of the positioning portion is greater than a thickness of the blade, so that a preset space is reserved between the blade and the sliding portion.

As a preference, each sliding portion is provided with a pair of sliding rails and a middle sliding chute; the middle sliding chute is recessed between the sliding rails; each side flange group includes a pair of side flanges and a pair of side sliding chutes; the side flanges are respectively arranged at the two side edges of the sliding portion in a protruding manner; the side sliding chutes are separately formed in the corresponding side flanges; groove faces of the side sliding chutes and the middle sliding chute are lower than upper surfaces of the siding rails; the main body portion further includes a pair of limiting side edges; the limiting side edges extend from an edge of the main body portion to the side sliding chutes of the knife rest, so that the limiting side edges of the moving component are slidably connected to the side sliding chutes of the knife rest.

As a preference, the positioning portion includes a first positioning portion and a second positioning portion; the first positioning portion and the second positioning portion are arranged along a center axis of the main body portion; the first positioning portion is arranged at a front end of the main body portion in a protruding manner; the second positioning portion is arranged at a rear end of the main body portion in a protruding manner; the protruding first positioning portion is clamped to a round hole in a front end of the blade; the second positioning portion is provided with a first positioning bevel and a second positioning bevel; the first positioning bevel tilts backward to a left direction; the second positioning bevel tilts backward to a right direction; and the first positioning bevel and the second positioning bevel separately support an inclined plane of a rear end of the blade.

As a preference, a width of the second positioning portion matches the middle sliding chute of the sliding portion, so that the second positioning portion is slidably arranged between the sliding rails; the main body portion further includes a magnetic portion; the magnetic portion is adjacent to the first positioning portion; and a magnet is mounted in the magnetic portion, so that the blade is attracted tightly by a magnetic force, and the blade tightly abuts against the main body portion.

As a preference, when the moving component is at an extending position, the first positioning portion is located in front of the knife rest; a preset distance is reserved between the first positioning portion and a front end surface of the knife rest, so that the first positioning portion is separated from the middle sliding chute of the knife rest; and the preset distance is suitable for taking out the blade from the first positioning portion.

As a preference, each side flange group further includes a limiting bulge; the limiting bulge is located at a front end of one side sliding chute; each main body portion further includes a sliding block; the sliding block radially extends outward from the limiting side edge on one side; the sliding block is located at a rear end of the limiting side edge; the sliding block is provided with an inward recessed limiting gap; a shape of the limiting gap matches a shape of the limiting bulge; and the limiting gap of the main body portion is suitable for locking the limiting bulge of the sliding portion, so that the moving component is located at a locked position or an unlocked position.

As a preference, each limiting side edge of the main body portion is of a multi-fold L-shaped structure; the limiting side edges downward and outward extend from an edge of the main body portion to keep the blade between the sliding rails and the main body portion; and the limiting side edges and the side flanges are in clearance fit.

As a preference, each retaining portion is provided with a first limiting surface, a connection portion, a retaining slot, and a first hanging post; the retaining slot is formed in the middle of the connection portion; the retaining slot accommodates the elastic member; the first limiting surface is located at a front end of the connection portion; the first hanging post extends from a rear end of the connection portion to the retaining slot; the extending portion includes a second hanging post, a front connection portion, and a rear connection portion; the front connection portion is connected to the main body portion and the rear connection portion; the second hanging post extends from the rear connection portion to the retaining slot; and two ends of the elastic member are respectively connected to the first hanging post and the second hanging post.

As a preference, the main body portion is provided with a second limiting surface at the rear end; a thickness of the main body portion is greater than a thickness of the extending portion; the second limiting surface is located on a critical line between the main body portion and the extending portion; when the moving component moves back to an initial position, the second limiting surface resists against the first limiting surface of the retaining portion; the rear connection portion is an inclined plane; a thickness of the rear connection portion gradually decreases from front to back; and an inclination amplitude of the rear connection portion adapts to the connection portion.

As a preference, the knife rest further includes a button; the button is located on one side surface of the knife rest; the button includes a cantilever and a button face; the cantilever forward extends from a rear end of the knife rest in a suspended manner, so that the button is elastic; the button face is located at a front end of the cantilever; correspondingly, a button hole is formed in one side surface of the knife shell; and the button hole is adapted to the button face, so that the button face protrudes from the button hole, and the knife holder is detachably fixed in the accommodating cavity of the knife shell.

As a preference, the knife shell includes the knife shell main body and a side shell component; a pair of moving slots are formed in an inner side of the knife shell main body; two outer sides of the knife holder are adapted to the moving slots, so that the knife holder is slidably connected to the knife shell to move back and forth along the moving slots; and a height of each moving slot is less than a height of a middle portion of the accommodating cavity.

As a preference, the knife holder further includes a blade storage box; a blade storage box slot is formed inside the retaining portions; the blade storage box is laterally mounted in the blade storage box slot in a separable manner; the blade storage box is provided with a blade storage box bulge; correspondingly, a blade storage box gap is formed in upper surfaces of the retaining portions; and the blade storage box gap matches the blade storage box bulge.

As a preference, the first blade and the second blade are trapezoid blades, horned blades or crescent-shaped blades; the knife shell is made of a zinc alloy metal material; and the knife rest and the moving components in the knife holder are separately molded by injection, so that the knife rest and the moving components are made of plastic materials.

### BRIEF DESCRIPTION OF THE DRAWINGS

FIG. 1 is a three-dimensional structural diagram of an art knife according to an embodiment of the present disclosure;

FIG. 2 is an exploded diagram of a knife shell according to a preferred embodiment of the present disclosure;

FIG. 3 is a front view of an art knife according to a preferred embodiment of the present disclosure;

FIG. 4 is a sectional view along a line A-A of FIG. 3 according to the present disclosure;

FIG. 5 is a three-dimensional structural diagram of a knife holder according to an embodiment of the present disclosure;

FIG. 6 is an exploded diagram of a knife holder according to an embodiment of the present disclosure;

FIG. 7 is a side view of a knife holder according to an embodiment of the present disclosure;

FIG. 8 is a partially enlarged diagram in FIG. 7 of the present disclosure;

FIG. 9 is a three-dimensional diagram (front surface) of a moving component according to an embodiment of the present disclosure;

FIG. 10 is a three-dimensional diagram (back surface) of a moving component according to an embodiment of the present disclosure;

FIG. 11 is a schematic structural diagram of a knife holder according to an embodiment of the present disclosure;

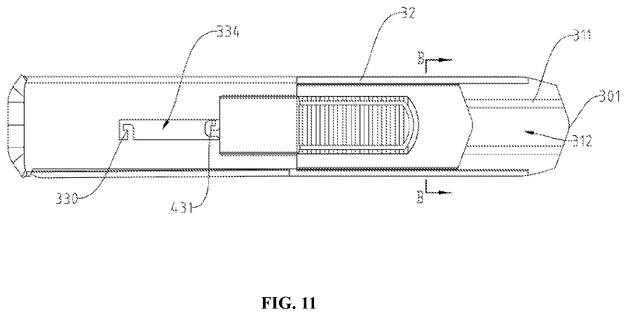

FIG. 12 is a sectional view along a line B-B of FIG. 11 according to the present disclosure;

FIG. 13 is a diagram of a usage state of a first blade according to an embodiment of the present disclosure; and

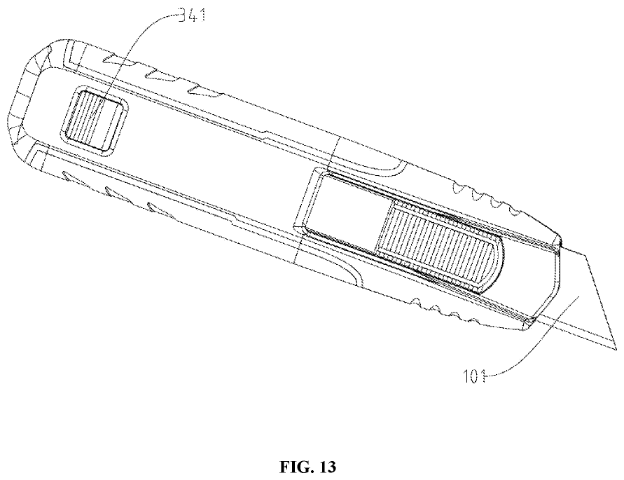

FIG. 14 is a diagram of a usage state of a second blade according to an embodiment of the present disclosure.

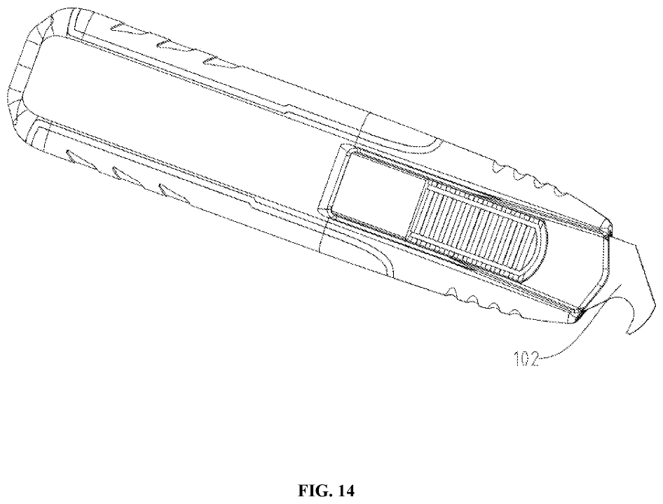

In the drawings: 1: art knife; 101: first blade; 102: second blade; 103: center axis; 2: knife shell; 20: knife shell main body; 201: accommodating cavity; 202: side shell slot; 203: button hole; 204: opening; 205: first opening; 206: second opening; 207: operating hole; 211: side shell; 212: side shell sleeve; 22: moving slot; 3: knife holder; 30: knife rest; 300: blade storage box gap; 301: front end surface; 302: blade storage box slot; 31: sliding portion; 311: sliding rail; 312: middle sliding chute; 32: side flange group; 321: first side flange; 322: first sliding chute; 323: second side flange; 324: second sliding chute; 325: limiting bulge; 33: retaining portion; 330: first hanging post; 331: first limiting surface; 332: connection portion; 334: retaining slot; 341: button; 342: cantilever; 343: button face; 40: moving component; 401: first moving component; 402: second moving component; 41: main body portion; 411: operating portion; 412: first limiting side edge; 413: second limiting side edge; 414: sliding block; 415: limiting gap; 42: positioning portion; 421: first positioning portion; 422: second positioning portion; 423: magnetic portion; 424: positioning slot; 425: empty slot; 426: second limiting surface; 427: first positioning bevel; 428: second positioning bevel; 43: extending portion; 431: second hanging post; 432: front connection portion; 433: rear connection portion; 44: elastic member; 5: blade storage box; 51: outer end portion; 52: fetching plate; and 53: blade storage box bulge.

### DETAILED DESCRIPTION OF THE EMBODIMENTS

The present disclosure is further described below in combination with specific implementations. It should be noted that the various embodiments or technical features described below can be arbitrarily combined to form new embodiments without conflicts.

In the description of the present disclosure, it should be noted that for orientation terms, orientations or positional relationships indicated by the terms “center”, “transverse”, “longitudinal”, “length” “width”, “thickness”, “upper”, “lower”, “front”, “rear”, “left”, “right”, “vertical”, “horizontal”, “top”, “bottom”, “inside”, “outside”, and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms cannot construed as limiting the specific protection scope of the present disclosure.

It should be noted that the terms “first”, “second”, etc. in the specification and claims of the present disclosure are used to distinguish similar objects, and do not have to be used to describe a specific order or sequence.

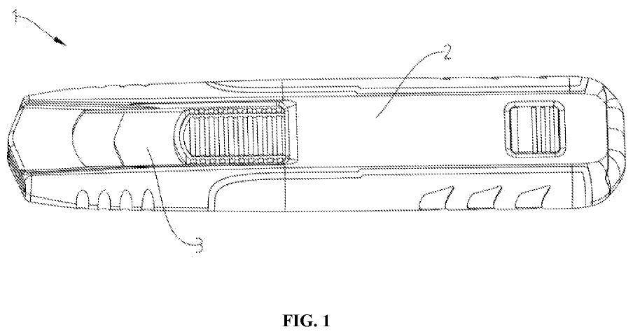

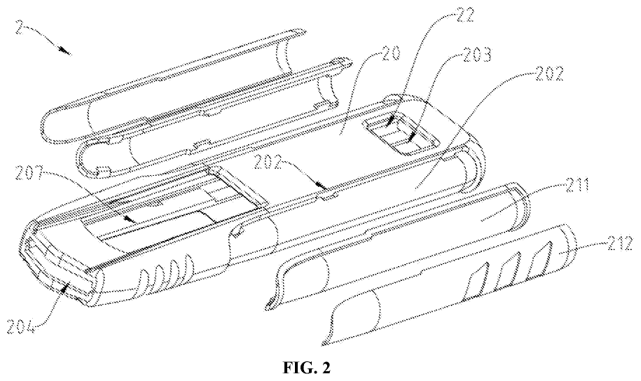

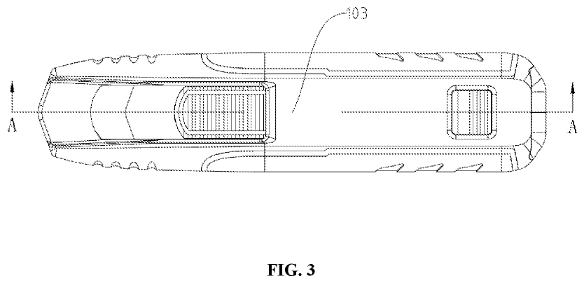

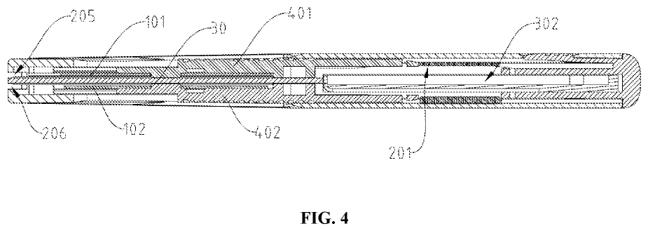

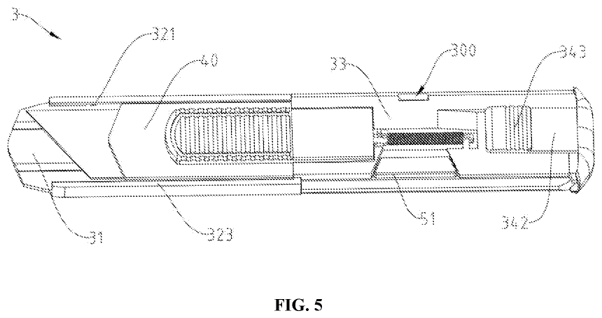

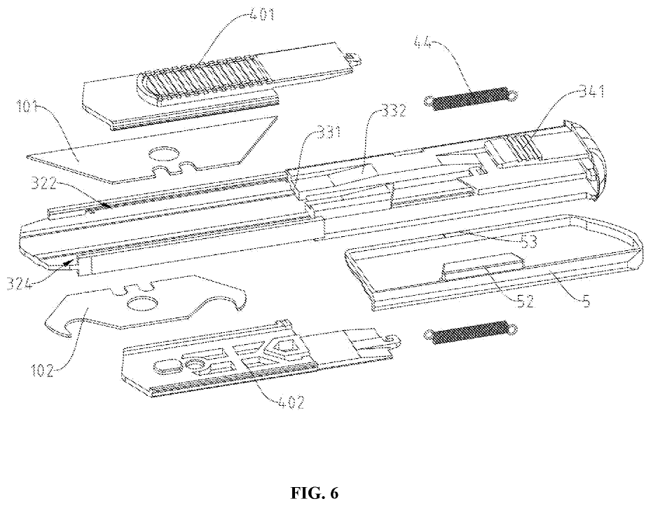

As shown in FIG. 1 to FIG. 6, a double-edged art knife 1 is shown. The double-edged art knife 1 includes a knife shell 2 and a knife holder 3. The knife shell 2 is provided with an accommodating cavity 201 and an opening 204. The opening 204 is formed in a front end of the knife shell 2. The opening 204 communicates the accommodating cavity 201 to the outside. The knife holder 3 is separably mounted in the accommodating cavity 201 of the knife shell 2. The opening 204 is divided by the knife holder 3 into a first opening 205 and a second opening 206. The knife holder 3 includes a knife rest 30 and a pair of moving components 40. The moving components 40 are symmetrically arranged on two sides of the knife rest 30. The moving components 40 include a first moving component 401 and the second moving component 402. The first moving component 401 bears a first blade 101 and can push the first blade 101 along one side of the knife shell 2 to extend out of the first opening 205 or retract back to the accommodating cavity 201. The second moving component 402 bears a second blade 102 and pushes the second blade 102 along the other side of the knife shell 2 to extend out of the second opening 206 or retract back to the accommodating cavity 201. Thus, the two blades are assembled in the two groups of symmetric moving components 40, so that 360° single-hand switching of two kinds of art knives 1 is quickly achieved, and the work efficiency is improved. Switching from the first blade 101 to the second blade 102 is achieved by only flipping the art knife 1 with a single hand, and the corresponding moving component 40 is pressed by the thumb to laterally push out the corresponding blade. The operation is convenient.

The knife rest 30 is provided with sliding portions 31, side flange groups 32, and retaining portions 33 on both a front surface and a back surface. The sliding portions 31 are located on a front side of the knife rest 30. The side flange groups 32 protrude along two side edges of the sliding portions 31. The retaining portions 33 are located on a rear side of the knife rest 30. The moving components 40 respectively face the front surface and the back surface of the knife rest 30. Rear ends of the moving components 40 are elastically connected to the retaining portions 33. Two side edges of the moving components 40 are slidably connected to the side flange groups 32 respectively, so that the moving components 40 slide back and forth along the sliding portions 31 to correspondingly drive the blades between the sliding portions 31 and the moving components 40 to slide back and forth. That is, the first moving component 401 is slidably connected to the front surface of the knife rest 30, and the second moving component 402 is slidably connected to the back surface of the knife rest 30. The structures of the front surface and the back surface of the knife rest 30 are basically in mirror symmetry. Thus, the first blade 101 between the first moving component 401 and the front surface of the knife rest 30 is laterally pushed, or the second blade 102 between the second moving component 402 and the back surface of the knife rest 30 is laterally pushed after switching with a single hand, so that a user neither needs to carry multiple art knives 1 nor needs to rummage for an art knife.

Each moving component 40 includes a main body portion 41, an extending portion 43, and an elastic member 44. The extending portion 43 extends from the main body portion 41 to the elastic member 44. The elastic member 44 is deformably connected to the extending portion 43 and the corresponding retaining portion of the knife rest 30. The main body portion 41 includes an operating portion 411 and a positioning portion 42. The operating portion 411 is located on an outer surface of the main body portion 41. A knife shell main body 20 is provided with a pair of operating holes 207. The operating holes 207 are separately formed in two side surfaces of the knife shell main body 20. The operating portion 411 faces each operating hole 207 of the knife shell main body 20, to facilitate the thumb to laterally operate and push the operating portion 411, so that the operating portion 411 moves back and forth along the operating hole 207. The positioning portion 42 protrudes out of an inner surface of the main body portion 41. The positioning portion 42 faces the corresponding sliding portion 31 of the knife rest 30, so that a positioning slot 424 is formed between the positioning portion 42 and the sliding portion 31. The positioning slot 424 is adapted to accommodate the blade, so that the blade is detachably fixed to the positioning portion 42. A protrusion height of the positioning portion 42 is greater than a thickness of the blade, so that a certain space is reserved between the blade and the sliding portion 31, which prevents friction between the blade and the sliding portion 31 of the knife rest 30 and avoids excessive wear of a surface of the blade.

An antiskid groove is formed in a surface of the operating portion 411, so that it is not easy to slip when a user pushes the moving component 40, and the operating experience is improved. Meanwhile, when a front end of the operating portion 411 resists against a front end of the operating hole 207, the operating portion 411 will be no longer pushed forward.

Each sliding portion 31 is provided with a pair of sliding rails 311 and a middle sliding chute 312. The middle sliding chute 312 is recessed between the sliding rails 311. Each side flange group 32 includes a pair of side flanges and a pair of side sliding chutes. The side flanges are respectively arranged at the two side edges of the sliding portion 31 in a protruding manner. The side sliding chutes are separately formed in the corresponding side flanges. The side sliding chutes and the middle sliding chute 312 are lower than the sliding rails 311. The main body portion 41 further includes a pair of limiting side edges. The limiting side edges extend from an edge of the main body portion 41 to the side sliding chutes of the knife rest 30, so that the limiting side edges of the moving component 40 can be slidably connected to the side sliding chutes of the knife rest 30. Meanwhile, groove faces of the side sliding chutes and the middle sliding chute 312 are lower than upper surfaces of the siding rails 311, when the moving component 40 slides back and forth, friction occurs between the limiting side edges on two sides of the moving component 40 and the side flanges on two sides of the knife rest 30, which avoids the friction between the blade and the knife rest 30 and prolongs the service life of the blade.

The positioning portion 42 includes a first positioning portion 421 and a second positioning portion 422. The first positioning portion 421 and the second positioning portion 422 are arranged along a center axis 103 of the main body portion 41 at an interval. The first positioning portion 421 is arranged at a front end of the main body portion 41 in a protruding manner. The second positioning portion 422 is arranged at a rear end of the main body portion 41 in a protruding manner. The protruding first positioning portion 421 is clamped to a round hole in a front end of the blade. The second positioning portion 422 is provided with a first positioning bevel 427 and a second positioning bevel 428. The first positioning bevel 427 tilts backward to a left direction, and the second positioning bevel 428 tilts backward to a right direction. The first positioning bevel 427 and the second positioning bevel 428 separately support an inclined plane of a rear end of the blade. For example, for a trapezoid blade, when a cutting edge of the blade is leftward, the first positioning bevel 427 supports the rear end of the blade; and hen the cutting edge of the blade is rightward, the second positioning bevel 428 supports the rear end of the blade. Thus, when the blade is in use, the first positioning bevel 427 and the second positioning bevel 428 contribute to supporting the position of the blade to prevent the blade from transversely shaking, so that the rear end of the blade always resists against the first positioning bevel 427 or the second positioning bevel 428, and switching of the art knife 1 for use with the left hand and the right hand is achieved. A left-hander does not need to select a specific left-handed art knife 1, but only needs to switch the blade.

A width of the second positioning portion 422 matches the middle sliding chute 312 of the sliding portion 31, so that the second positioning portion 422 is slidably arranged between the sliding rails 311. That is, a horizontal width of the second positioning portion 422 is slightly less than that of the middle sliding chute 312, which is conductive to keeping the second positioning portion 422 of the moving component 40 sliding back and forth along the middle sliding chute 312, so that the second positioning portion 422 is locked between the sliding rails 311; the stability of use of the blade is guaranteed; and shaking of the blade is prevented. Meanwhile, the protruding structure of the second positioning portion 422 can also improve the structural strength of the moving component 40. A force applying position of the thumb is basically the position of the second positioning portion 422, so that a force bearing point is supported, and the stability of use of the moving component 40 is guaranteed.

The main body portion 41 further includes a magnetic portion 423. The magnetic portion 423 is adjacent to the first positioning portion 421. A magnet is mounted in the magnetic portion 423, so that the blade is attracted tightly by a magnetic force, and the blade tightly abuts against the main body portion 41, which further prevents the blade from being separated from the first positioning portion 421 or shaking during the use. In addition, the magnetic portion 423 is also conductive to removal and replacement of the blade.

The main body portion 41 is provided with a plurality of empty slots 425. The empty slots 425 are located between the first positioning portion 421 and the second positioning portion 422. The empty slots 425 are economizing slots, and a wall thickness of the main body portion 41 is more uniform, which prevents deformation, shrinkage, or the like in an injection molding process of the moving component 40 due to a non-uniform wall thickness, increases the percent of pass of production of the moving component 40, and reduces the manufacturing cost.

When the moving component 40 is at an extending position, the blade is pushed to the frontmost end, and the first positioning portion 421 is located in front of the knife rest 30. A preset distance is reserved between the first positioning portion 421 and a front end surface 301 of the knife rest 30, so that the first positioning portion 421 is separated from the middle sliding chute 312 of the knife rest 30. The preset distance is suitable for enlarging the space between the main body portion 41 and the sliding portion 31 during fetching of the blade, which is convenient for taking out the blade and placing the blade again, to achieve replacement of the blade. For example, the blade is switched to achieve alternative use with the left hand and the right hand, preventing the front end of the knife rest 30 from interfering with the replacement of the blade. If the first positioning portion 421 is too close to the front end surface 301 of the knife rest 30, or if the first positioning portion 421 is not separated from the middle sliding chute 312, the space between the main body portion 41 and the sliding portion 31 cannot be enlarged by an external force, and the blade cannot be taken out.

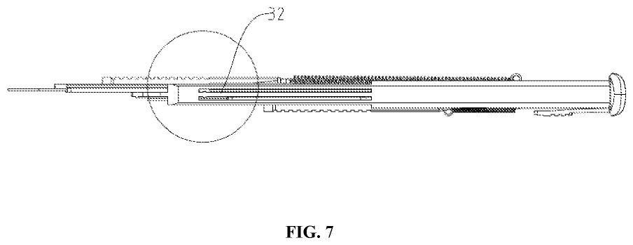

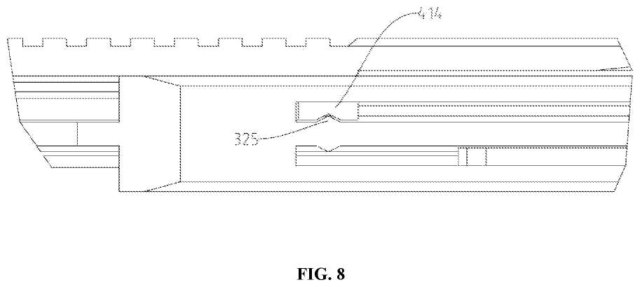

Each side flange group 32 further includes a limiting bulge 325. The limiting bulge 325 is located at a front end of one side sliding chute. Each main body portion 41 further includes a sliding block 414. The sliding block 414 radially extends outward from the limiting side edge on one side. The sliding block 414 is located at a rear end of the limiting side edge. The sliding block 414 is provided with an inward recessed limiting gap 415. A shape of the limiting gap 415 matches a shape of the limiting bulge 325. The limiting gap 415 of the main body portion 41 is suitable for locking the limiting bulge 325 of the sliding portion 31, so that the moving component 40 is located at a locked position or an unlocked position. When the moving component 40 is located at the locked position, the sliding block 414 at the rear end of the moving component 40 is locked to the limiting bulge 325 at the front end of the knife rest 30 through the limiting gap 415 to keep the moving component 40 driving the blade to be located at the front end, so that the first positioning portion 421 of the moving component 40 is separated from the middle sliding chute 312 of the knife rest 30 to facilitate the replacement of the blade and to prevent the moving component 40 from accidentally returning backward to an initial position during the replacement. After the replacement is completed, the moving component 40 slides backward under a force, and the sliding block 414 of the moving component 40 is separated from the limiting bulge 325 of the knife rest 30. When the moving component 40 is located at the unlocked position, the moving component 40 automatically moves backward under a resilience force of the elastic member 44. Thus, the knife holder 3 has a compact structure. By using a configuration type assembled structure, it is convenient to change edge directions of blades, which is helpful to achieve a switching operation of the left hand and the right hand, and improves the universality of the art knife 1, as shown in FIG. 7 to FIG. 8.

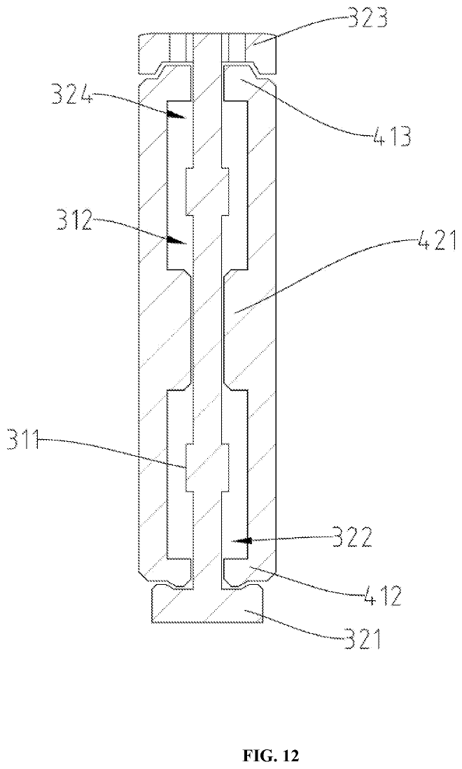

Each limiting side edge of the main body portion 41 is of a multi-fold L-shaped structure. The limiting side edges downward and outward extend from an edge of the main body portion 41 to keep a lower surface of the limiting side edge and a lower surface of the positioning portion 42 consistent and keep the blade between the sliding rails 311 and the main body portion 41. The limiting side edges extend from the main body portion 41 to the sliding chutes in the side flange group 32, thus moving back and forth along the sliding chutes. The limiting side edges and the side flanges are in clearance fit. Certain clearances are reserved between the limiting side edges and the side flanges in a vertical direction. The clearances are convenient for the sliding of the moving component 40, so as to avoid such a phenomenon that the moving component 40 is deadly clamped and cannot slide. In addition, it is conductive to pushing the front end of the moving component 40 during the replacement of the blade, so that the moving component is slightly upwarped to facilitate taking out the blade, as shown in FIG. 12.

In other words, the side flanges include a first side flange 321 and a second side flange 323. The side sliding chutes include a first sliding chute 322 and a second sliding chute 324. The first side flange 321 and the second side flange 323 separately protrude out along two side edges of the sliding portion 31. The first sliding chute 322 is formed in the first side flange 321, and the second sliding chute 324 is formed in the second side flange 323. The limiting bulge 325 is located at a front end of the first sliding chute 322. The limiting side edges include a first limiting side edge 412 and a second limiting side edge 413. The first limiting side edge 412 is slidably connected to the first side flange 321. The second limiting side edge 413 is slidably connected to the second side flange 323. The sliding block 414 is located at a rear end of the first limiting side edge 412. When the sliding block 414 moves to the front end of the first side flange 321 from back to front, the limiting bulge 325 of the first side flange 321 locks the limiting gap 415 of the sliding block 414. The sliding block 414 is pressed between the limiting bulge 325 and the first side flange 321, so that the moving component 40 is kept stationary to facilitate replacing the blade.

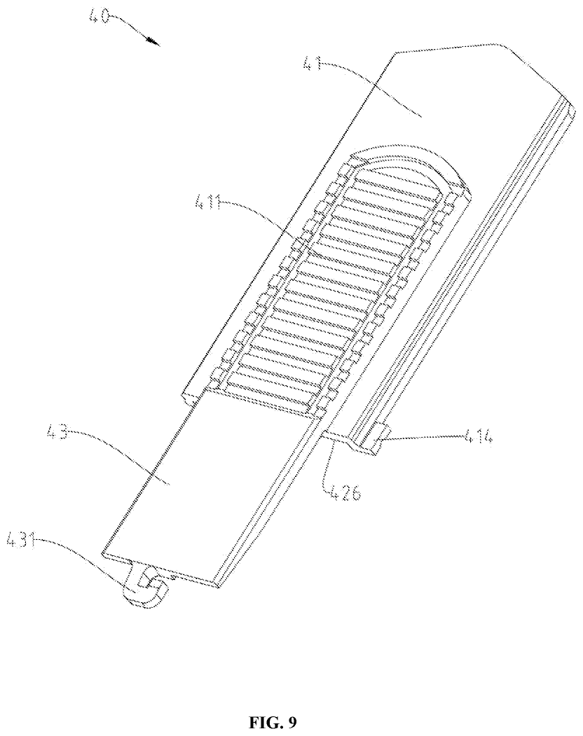

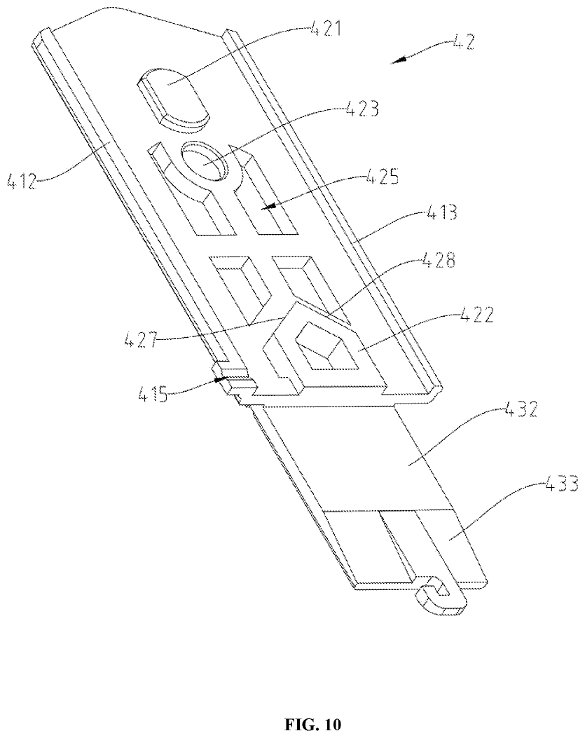

Each retaining portion 33 is provided with a first limiting surface 331, a connection portion 332, a retaining slot 334, and a first hanging post 330. The retaining slot 334 is formed in the middle of the connection portion 332, and the retaining slot 334 may accommodate the elastic member 44. The first limiting surface 331 is located at a front end of the connection portion 332. The first hanging post 330 extends from a rear end of the connection portion 332 to the retaining slot 334. The extending portion 43 includes a second hanging post 431, a front connection portion 432, and a rear connection portion 433. The front connection portion 432 is connected to the main body portion 41 and the rear connection portion 433. The second hanging post 431 extends from the rear connection portion 433 to the retaining slot 334. Two ends of the elastic member 44 are respectively connected to the first hanging post 330 and the second hanging post 431. That is, the retaining slot 334 is formed along the center axis 103 of the knife rest 30. The first hanging post 330 and the second hanging post 431 are arranged in tandem, so that it is convenient for the elastic member 44 to pull the moving component 40 to return to an initial position. The retaining slot 334 makes a reasonable use of a space of the knife rest 30, so that the structure of the knife holder 3 is more compact, which is conductive to reducing the volume of the art knife 1, as shown in FIG. 9 to FIG. 10.

The main body portion 41 is provided with a second limiting surface 426 at the rear end. A thickness of the main body portion 41 is greater than a thickness of the extending portion 43. The second limiting surface 426 is located on a critical line between the main body portion 41 and the extending portion 43. When the moving component 40 moves back to the initial position, the second limiting surface 426 resists against the first limiting surface 331 of the retaining portion 33. The rear connection portion 433 is an inclined plane. A thickness of the rear connection portion 433 gradually decreases from front to back. An inclination amplitude of the rear connection portion 433 adapts to the connection portion 332. When the moving component 40 is forward pushed, a distance between the rear connection portion 433 and the retaining portion 33 is increasingly large, which avoids an interference phenomenon during sliding. Meanwhile, a thickness of the connection portion 332 gradually increases from front to back, which is conductive to improving the structural strength of a rear end of the knife rest 30, avoiding an ultra-thin structure of the connection portion 332 of the knife rest 30, improving the stability of supporting the two moving components 40 by the front surface and the back surface of the knife rest 30, and prolonging the service life. Thus, when the blade extends out of the shell under a lateral thrust, the elastic member 44 is stretched. When the external force is withdrawn, the moving component 40 is quickly reset by a pull force of the elastic member 44 until the second limiting surface 426 of the main body portion 41 resists against the first limiting surface 331 of the knife rest 30, so that the blade is quickly withdrawn into the accommodating cavity 201, which facilitates single-hand operations.

The knife rest 30 further includes a button 341. The button 341 is located on one side surface of the knife rest 30. The button 341 includes a cantilever 342 and a button face 343. The cantilever 342 forward extends from the rear end of the knife rest 30 in a suspended manner, so that the button 341 is elastic. The button face 343 is located at a front end of the cantilever 342. By using the cantilever 342, the button face 343 may move up and down in an elastic range. Correspondingly, a button hole 203 is formed in one side surface of the knife shell 2. The button hole 203 is adapted to the button face 343, so that the button face 343 protrudes from the button hole 203, and the knife holder 3 is detachably fixed in the accommodating cavity 201 of the knife shell 2. That is, the button face 343 on the knife rest 30 passes through the button hole 203 to be exposed from an outer surface of the knife shell 2. The button face 343 is provided with a striated bulge to facilitate operations. If a user pushes the button 341, the button 341 may be easily separated from the button hole 203 to further separate the knife holder 3 from the knife shell 2, and the knife holder 3 is taken out to replace the blade.

The knife shell 2 includes the knife shell main body 20 and a side shell component. A pair of moving slots 22 are formed in an inner side of the knife shell main body 20. Two outer sides of the knife holder 3 are adapted to the moving slots 22, so that the knife holder 3 is slidably connected to the knife shell 2 to move back and forth along the moving slots 22. Meanwhile, a height of each moving slot 22 is less than a height of a middle portion of the accommodating cavity 201, to fully match the shape of the knife holder 3, which prevents unnecessary shake of the knife holder 3, ensures the stability of cutting of the blade, and improves the travel accuracy of the blade. The side shell component is detachably connected to a side edge of the knife shell 2. The side shell component includes a side shell 211 and a side shell sleeve 212. A side shell slot 202 is formed in a side edge of the knife shell main body 20. The side shell 211 is separably mounted in the side shell slot 202. The side shell sleeve 212 is fixed on an outer side of the side shell 211. The side shell sleeve 212 is made of a soft elastic material, such as rubber and silica gel, which improves the comfortable sensation of a user, particularly when the user grips the side shell sleeve 212 with fingers. The side shell 211 may be mounted in the side shell slot 202 in a fastening manner. The side shell sleeve 212 may be fixed on the side shell 211 by adhesion or in other ways.

The knife holder 3 further includes a blade storage box 5. A blade storage box slot 302 is formed inside the retaining portions 33. The blade storage box 5 is laterally mounted in the blade storage box slot 302 in a separable manner. That is, the blade storage box 5 is placed in the blade storage box slot 302 in a pullable manner. An outer end portion 51 of the blade storage box 5 is located on one side of the retaining portions 33. The outer end portion 51 abuts against the knife rest 30. Blades for replacement can be placed in the blade storage box 5, so that the blades of the art knife 1 can be replaced at any time.

The blade storage box 5 is provided with a blade storage box bulge 53. Correspondingly, a blade storage box gap 300 is formed in upper surfaces of the retaining portions 33. The blade storage box gap 300 matches the blade storage box bulge 53. When the blade storage box 5 is completely stored in the blade storage box slot 302, the blade storage box bulge 53 falls into the blade storage box gap 300, so that the blade storage box 5 is detachably fixed on the knife rest 30. A fetching plate 52 is arranged at the outer end portion 51 of the blade storage box 5, so that it is more convenient to quickly take out the blade storage box 5 from the blade storage box slot 302. Thus, the blade storage box 5 moves between a closed position and an opened position. When the blade storage box 5 is at the closed position, the blade storage box 5 is pushed into the blade storage box slot 302, and a standby blade is hidden in the blade storage box 5. When the blade storage box 5 is at the opened positioned, the blade storage box 5 is pulled out of the blade storage box slot 302, so that a user is allowed to take out the standby blade from the blade storage box 5.

The first blade 101 and the second blade 102 may be trapezoid blades, horned blades or crescent-shaped blades. Different blades are selected according to different art modelings and material cutting requirements. A horned blade can perform curve cutting to cut and trim relatively thick materials such as a roof material, a fabric, a PVC flooring, and a corrugated box. A trapezoid blade is mainly used for linear cutting, for example, cable cutting. If the first blade 101 adopts the trapezoid blade, and the second blade 102 adopts the horned blade, to alternately use the different blades, the art knife 1 is flipped with one hand to switch the first blade 101 beside the thumb to the second blade 102, and the second moving component 402 bearing the second blade 102 is laterally pushed, so that the second blade 102 may be pushed out from the opening 204. Thus, two kinds of different blades are arranged on one art knife 1, and the corresponding blades are laterally pushed out for use, which ensures the bearing strength of the knife holder 3, without additionally increasing a thickness of the art knife 1, so that a complicated locking structure is not required, the operation is simple, and the cost is low.

The knife shell 2 is made of a zinc alloy metal material to ensure the strength of the knife shell 2. The knife rest 30 and the moving components 40 in the knife holder 3 are separately molded by injection, so that the knife rest 30 and the moving components 40 are made of plastic materials, which facilitates use and reduces the cost.

The knife shell 2 is of a symmetric structure along the center axis 103. No matter whether the knife shell 2 is flipped for use with one hand or alternately used with the left hand and right hand, the feeling of using the knife shell 2 is the same.

The above describes the basic principle, main characteristics and advantages of the present disclosure. Those skilled in the art should understand that the present disclosure is not limited by the foregoing embodiments. The foregoing embodiments and the specification only illustrate the principles of the present disclosure. The present disclosure may have various changes and improvements without departing from the spirit and scope of the present disclosure, and these changes and improvements all fall within the scope claimed by the present disclosure. The claimed scope of the present disclosure is defined by the appended claims and their equivalents.

What is claimed is:

1. A double-edged art knife, comprising:
a knife shell, provided with an accommodating cavity and an opening, wherein the opening is formed in a front end of the knife shell; and
a knife holder, separably mounted in the accommodating cavity of the knife shell, wherein the opening is divided by the knife holder into a first opening and a second opening; the knife holder comprises a knife rest and a pair of moving components; the moving components are symmetrically arranged on two sides of the knife rest; the moving components comprise a first moving component and the second moving component; the first moving component bears a first blade and pushes the first blade along one side of the knife shell to extend out of the first opening or retract back to the accommodating cavity; and the second moving component bears a second blade and pushes the second blade along the other side of the knife shell to extend out of the second opening or retract back to the accommodating cavity.

2. The double-edged art knife according to claim 1, wherein the knife rest is provided with sliding portions, side flange groups, and retaining portions on both a front surface and a back surface; the sliding portions are located on a front side of the knife rest; the side flange groups protrude along two side edges of the sliding portions; the retaining portions are located on a rear side of the knife rest; the moving components respectively face the front surface and the back surface of the knife rest; rear ends of the moving components are elastically connected to the retaining portions; two side edges of the moving components are slidably connected to the side flange groups respectively, so that the moving components slide back and forth along the sliding portions.

3. The double-edged art knife according to claim 2, wherein each moving component comprises a main body portion, an extending portion, and an elastic member; the extending portion extends from the main body portion to the elastic member; the elastic member is deformably connected to the extending portion and the corresponding retaining portion of the knife rest; the main body portion comprises an operating portion and a positioning portion; the operating portion is located on an outer surface of the main body portion; a knife shell main body is provided with a pair of operating holes; the operating holes are separately formed in two side surfaces of the knife shell main body, so that the various operating portions are located in the operating holes of the knife shell main body; the positioning portion protrudes out of an inner surface of the main body portion; the positioning portion faces the corresponding sliding portion of the knife rest, so that the blade is detachably fixed to the positioning portion; and a protrusion height of the positioning portion is greater than a thickness of the blade, so that a preset space is reserved between the blade and the sliding portion.

4. The double-edged art knife according to claim 3, wherein each sliding portion is provided with a pair of sliding rails and a middle sliding chute; the middle sliding chute is recessed between the sliding rails; each side flange group comprises a pair of side flanges and a pair of side sliding chutes; the side flanges are respectively arranged at the two side edges of the sliding portion in a protruding manner; the side sliding chutes are separately formed in the corresponding side flanges; groove faces of the side sliding chutes and the middle sliding chute are lower than upper surfaces of the siding rails; the main body portion further comprises a pair of limiting side edges; the limiting side edges extend from an edge of the main body portion to the side sliding chutes of the knife rest, so that the limiting side edges of the moving component are slidably connected to the side sliding chutes of the knife rest.

5. The double-edged art knife according to claim 4, wherein the positioning portion comprises a first positioning portion and a second positioning portion; the first positioning portion and the second positioning portion are arranged along a center axis of the main body portion; the first positioning portion is arranged at a front end of the main body portion in a protruding manner; the second positioning portion is arranged at a rear end of the main body portion in a protruding manner; the protruding first positioning portion is clamped to a round hole in a front end of the blade; the second positioning portion is provided with a first positioning bevel and a second positioning bevel; the first positioning bevel tilts backward to a left direction; the second positioning bevel tilts backward to a right direction; and the first positioning bevel and the second positioning bevel separately support an inclined plane of a rear end of the blade.

6. The double-edged art knife according to claim 5, wherein a width of the second positioning portion matches the middle sliding chute of the sliding portion, so that the second positioning portion is slidably arranged between the sliding rails; the main body portion further comprises a magnetic portion; the magnetic portion is adjacent to the first positioning portion; a magnet is mounted in the magnetic portion, so that the blade is attracted tightly by a magnetic force, and the blade tightly abuts against the main body portion; when the moving component is at an extending position, the first positioning portion is located in front of the knife rest; a preset distance is reserved between the first positioning portion and a front end surface of the knife rest, so that the first positioning portion is separated from the middle sliding chute of the knife rest; and the preset distance is suitable for taking out the blade from the first positioning portion.

7. The double-edged art knife according to claim 6, wherein each side flange group further comprises a limiting bulge; the limiting bulge is located at a front end of one side sliding chute; each main body portion further comprises a sliding block; the sliding block radially extends outward from the limiting side edge on one side; the sliding block is located at a rear end of the limiting side edge; the sliding block is provided with an inward recessed limiting gap; a shape of the limiting gap matches a shape of the limiting bulge; and the limiting gap of the main body portion is suitable for locking the limiting bulge of the sliding portion, so that the moving component is located at a locked position or an unlocked position.

8. The double-edged art knife according to claim 7, wherein each limiting side edge of the main body portion is of a multi-fold L-shaped structure; the limiting side edges downward and outward extend from an edge of the main body portion to keep the blade between the sliding rails and the main body portion; and the limiting side edges and the side flanges are in clearance fit.

9. The double-edged art knife according to claim 8, wherein each retaining portion is provided with a first limiting surface, a connection portion, a retaining slot, and a first hanging post;
the retaining slot is formed in the middle of the connection portion; the retaining slot accommodates the elastic member; the first limiting surface is located at a front end of the connection portion; the first hanging post extends from a rear end of the connection portion to the retaining slot; the extending portion comprises a second hanging post, a front connection portion, and a rear connection portion; the front connection portion is connected to the main body portion and the rear connection portion; the second hanging post extends from the rear connection portion to the retaining slot; and two ends of the elastic member are respectively connected to the first hanging post and the second hanging post.

10. The double-edged art knife according to claim 9, wherein the main body portion is provided with a second limiting surface at the rear end; a thickness of the main body portion is greater than a thickness of the extending portion; the second limiting surface is located on a critical line between the main body portion and the extending portion; when the moving component moves back to an initial position, the second limiting surface resists against the first limiting surface of the retaining portion; the rear connection portion is an inclined plane; a thickness of the rear connection portion gradually decreases from front to back; and an inclination amplitude of the rear connection portion adapts to the connection portion.

11. The double-edged art knife according to claim 10, wherein the knife holder further comprises a blade storage box; a blade storage box slot is formed inside the retaining portions; the blade storage box is laterally mounted in the blade storage box slot in a separable manner; the blade storage box is provided with a blade storage box bulge; correspondingly, a blade storage box gap is formed in upper surfaces of the retaining portions; the blade storage box gap matches the blade storage box bulge; the knife shell comprises the knife shell main body; a pair of moving slots are formed in an inner side of the knife shell main body; two outer sides of the knife holder are adapted to the moving slots, so that the knife holder is slidably connected to the knife shell to move back and forth along the moving slots; and a height of each moving slot is less than a height of a middle portion of the accommodating cavity.

12. The double-edged art knife according to claim 11, wherein the knife rest further comprises a button; the button is located on one side surface of the knife rest; the button comprises a cantilever and a button face; the cantilever forward extends from a rear end of the knife rest in a suspended manner, so that the button is elastic; the button face is located at a front end of the cantilever; correspondingly, a button hole is formed in one side surface of the knife shell; and the button hole is adapted to the button face, so that the button face protrudes from the button hole, and the knife holder is detachably fixed in the accommodating cavity of the knife shell.

13. The double-edged art knife according to claim 11, wherein the first blade and the second blade are trapezoid blades, horned blades or crescent-shaped blades; the knife shell is made of a zinc alloy metal material; and the knife rest and the moving components in the knife holder are separately molded by injection, so that the knife rest and the moving components are made of plastic materials.
